(19) United States
(12) Patent Application Publication
(10) Pub. No.: US 2016/0198702 A1
(43) Pub. Date: Jul. 14, 2016

(54) FLYING DUCK DECOY

(71) Applicant: Ryan FORRESTER, Hoschton, GA (US)

(72) Inventor: Ryan FORRESTER, Hoschton, GA (US)

(21) Appl. No.: 14/995,759

(22) Filed: Jan. 14, 2016

Related U.S. Application Data
(60) Provisional application No. 62/103,543, filed on Jan. 14, 2015.

(51) Int. Cl. A01M 31/06; G08C 17/02

(52) U.S. Cl. CPC A01M 31/06; G08C 17/02

(57) ABSTRACT

A duck decoy has rotors mounted in its wings which provide lift. The motors, and control surfaces on the decoy, are controlled automatically or remotely so the decoy can take off, cruise autonomously, and land on ground or water.

This application claims benefit of provisional application 62/103543, filed Jan. 14, 2015.

### BACKGROUND OF THE INVENTION

This invention relates to a flying duck decoy.

“Motion Decoy” is an industry standard term that refers to a variety of waterfowl decoys that utilize some form of movement to provide more realism.

One product on the market is known as a spinning wing decoy that is fixed to a pole that puts the decoy several inches above the water and rotates/spins the wings about an axis.

Some other motion decoys available use some combination of swimming/spinning wings/or splashing created by a water pump.

There is no product currently on the market that is capable of true flight, where the decoy itself can take off and land.

### SUMMARY OF THE INVENTION

An object of the invention is to provide a duck decoy having improved realism, and capable of actual flight, i.e., one that simulates a duck, taking off from the water and landing back down on the water.

This and other objects are achieved by a remote controlled drone resembling an animal such as a duck or other fowl, that is capable of autonomous flight as well as user controlled flight, as described below.

The invention utilizes a standard bicopter design in which the propellers reside in the wings of the decoy The propellers are powered by electric motors that are pitch/yaw controlled by servos, used in conjunction with an on board flight controller this provides for smooth flight.

The decoy can be operated by a remote pre-programmed controller.

The decoy can also be operated manually from an R/C controller that is manipulated by a user to allow the user to determine the flight path and duration.

### BRIEF DESCRIPTION OF THE DRAWINGS

In the accompanying drawing,

FIG. 1 is a perspective view of a flying duck decoy embodying the invention;

FIG. 2 is a schematic showing electrical components of the invention;

FIG. 3 is a schematic showing an remote-control embodiment of the invention;

FIG. 3 is a schematic showing an alternative remote-control embodiment; and

FIG. 5 is a perspective view of an alternative form of the decoy.

### DESCRIPTION OF THE PREFERRED EMBODIMENT

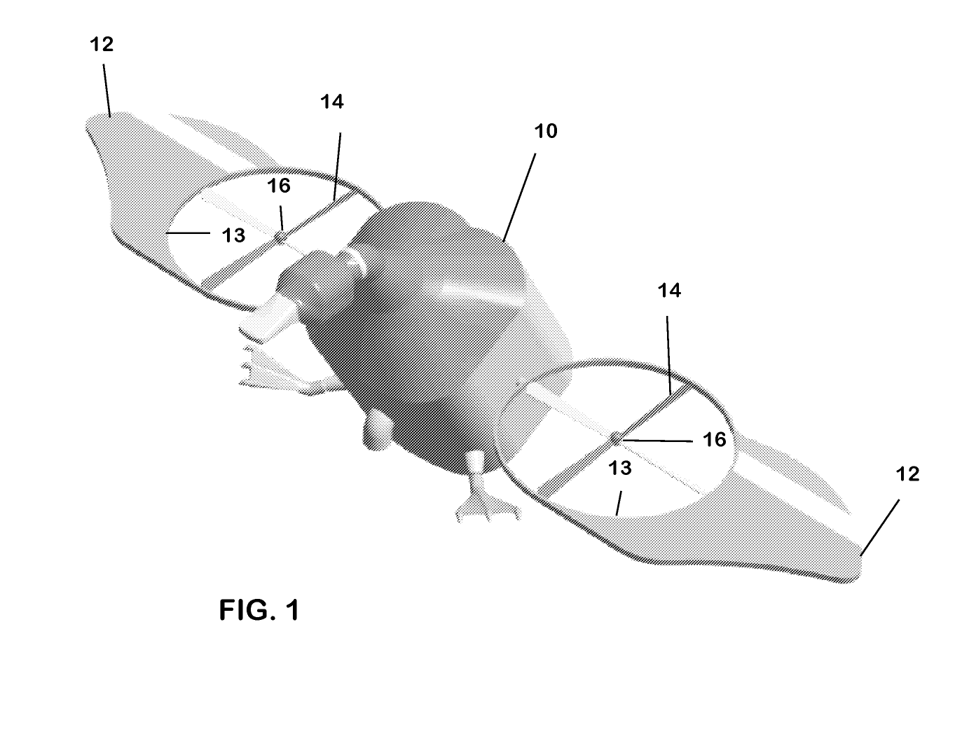

A flying duck decoy embodying the invention, as shown in FIG. 1, includes a body 10 which resembles a duck or other fowl and can float in water.

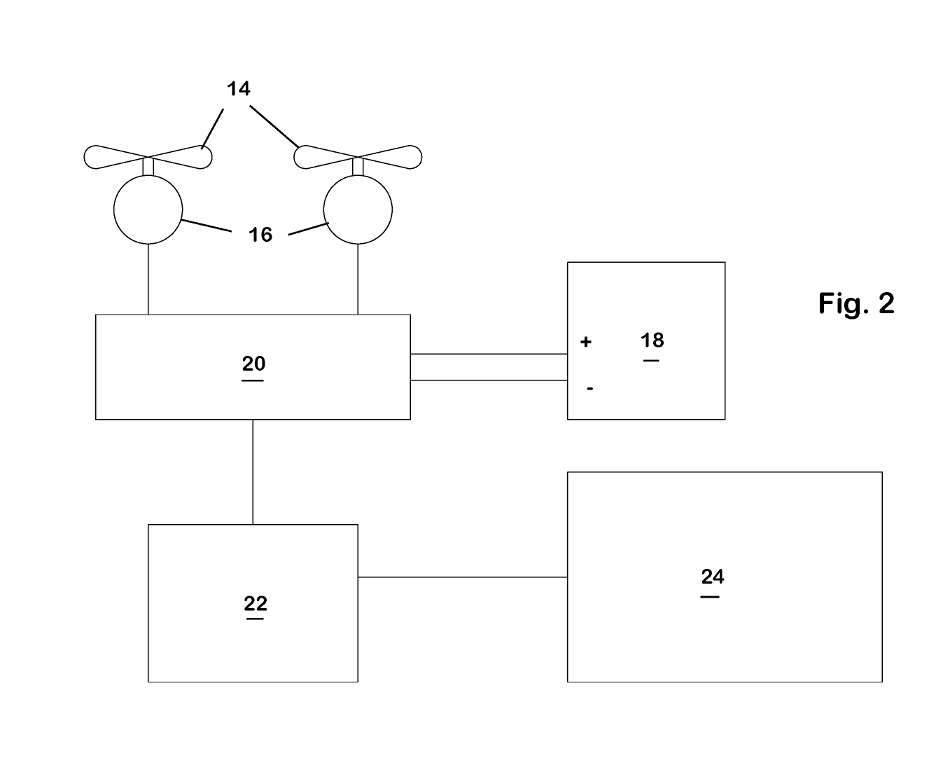

The body has a pair of wings 12 extending therefrom. Each wing has an aperture 13 with a rotor 14 disposed therein, in the form of a propellor driven by a motor 16. A preferred propellor is a 11″×4.7″ Carbon Fiber CW CCW Propeller, available from RCTimer Power Model Co., Ltd, Hong Kong (rctimer.com). The motor is preferably electric, powered by a battery 18 (FIG. 2) inside the body. A suitable motor is the Rctimer 5010-530KV Multicopter Brushless Motor.

The respective motor speeds are controlled by an on-board flight regulator 20, which can be pre-programmed to run a sequence of takeoff, short mid-air flight time, and descent/landing. A suitable speed regulator is the RCTimer NFS ESC 45A (OPTO) Speed Controller.

The regulator is paired with a flight controller 22 which controls and the pitch and yaw of the propellors, and optionally other aerodynamic surfaces. A suitable controller is the HobbyKing KK2.1HC Multi-Rotor Hard Case Flight Control Board With Remote Programmer “HobbyKing” is a registered trademark of hexTronik Limited Company, Hong Kong.

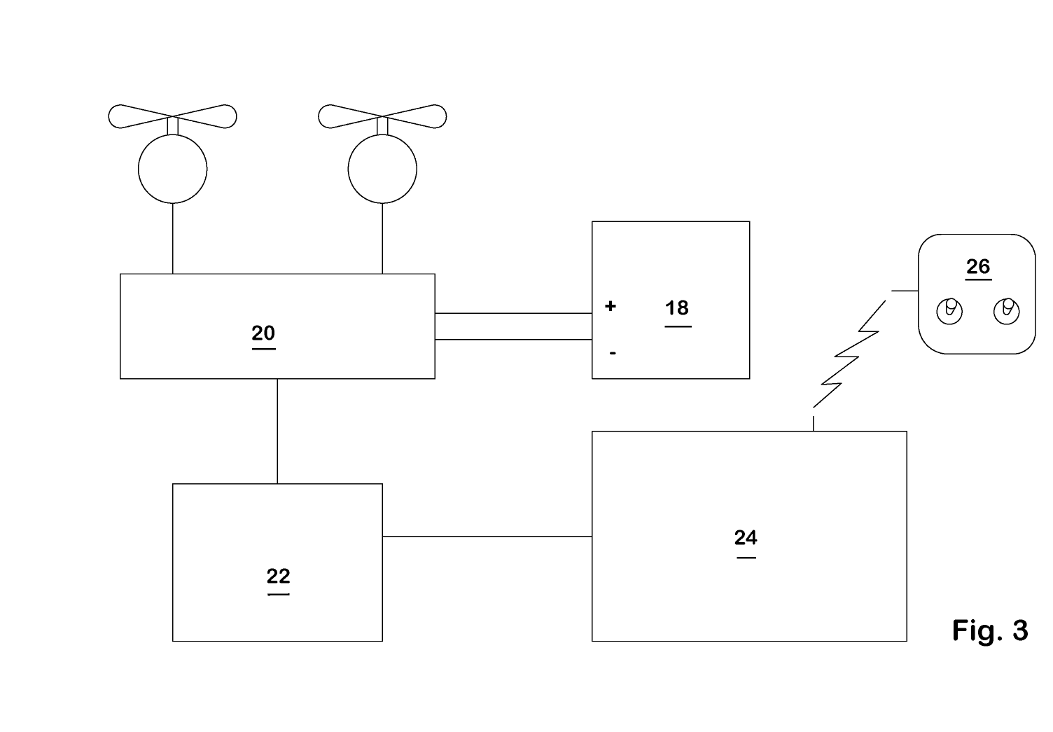

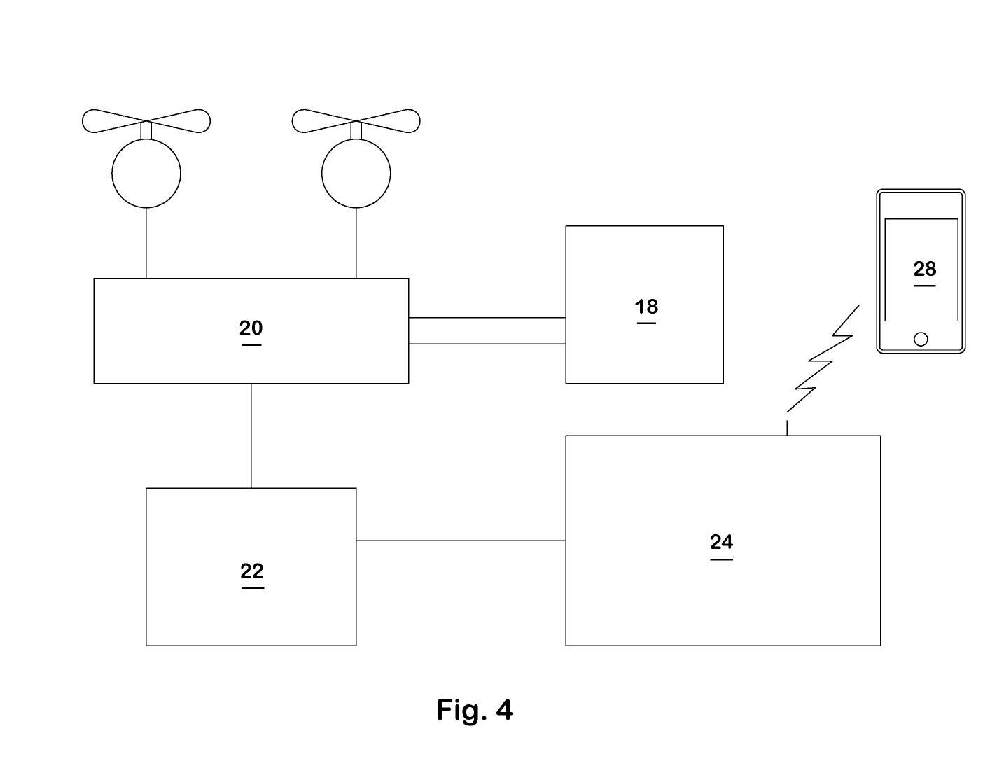

Alternatively, or in addition, the controller can include a radio receiver 24 (FIG. 3), responsive to a remote hand-held radio transmitter 26. A suitable transmitter/receiver is the Hobby King 2.4 Ghz 6 Ch Tx & Rx V2—Mode 2.

As a further alternative, shown in FIG. 4, a cell phone 28 or similar device on a cellular network, running an app designed to control the decoy, might be used in place of a radio transmitter.

The body can have movable control surfaces thereon, whose position is regulated by servos actuated by the controller. Hitec 326455 HS-645MG High Torque 2BB Metal Gear Servos are suitable for this application.

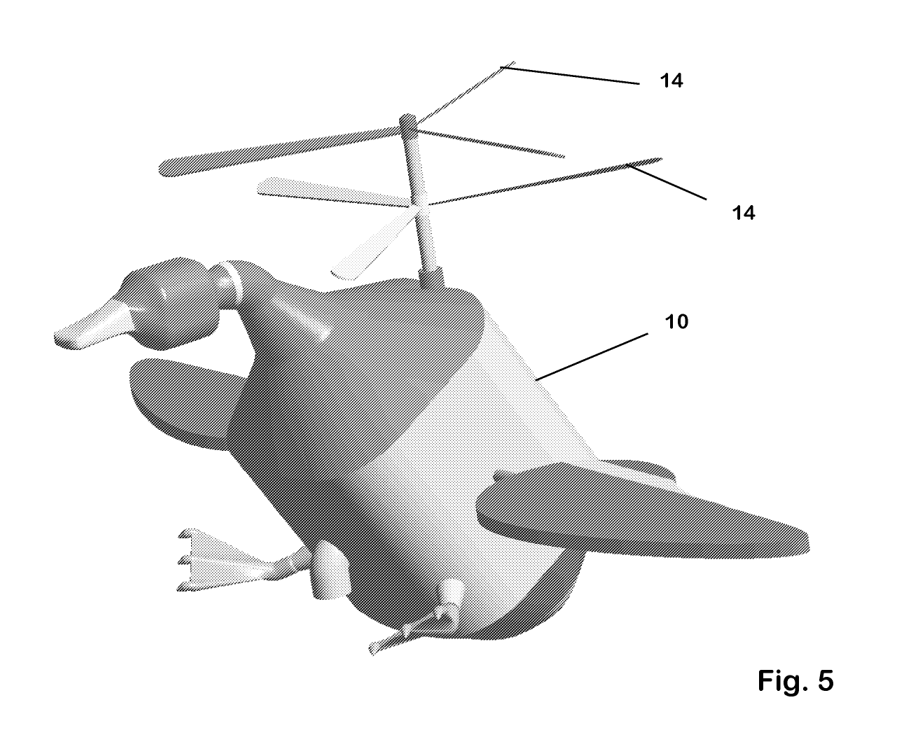

While the presently preferred location of the propellors is in the wings, it would be possible to create an alternative form of the invention in which the propellors 14 are supported on another part of the body 10. One such alternative is shown in FIG. 5. In this case, the motors for the propellors could be situated inside the body 10. Other variations may prove useful as well.

Radio controlled model helicopters are well known. Their construction being a matter of ordinary design skill, further details are not described above.

Specific hardware components are identified above to enable a person of ordinary skill to make and use the invention. However, other functionally similar components may be substituted, and may even prove superior. Since the invention is subject to such substitutions and other modifications, the foregoing description and the accompanying drawing should be interpreted as only illustrative of the invention, whose scope is to be measured by the claims below.

I claim:

1. A decoy comprising
a body resembling the body of an animal,
means for generating a lifting force on said body to enable it to fly through air, and
a system for controlling said rotor and for regulating the orientation of said body.

2. The invention of claim 1, wherein the means for generating a lifting force is a propellor and a motor for driving the propellor.

3. The invention of claim 1, wherein the means for generating a lifting force comprises plural propellors and respective motors for driving said propellors.

4. The invention of claim 3, wherein said propellors turn about substantially vertical axes.

5. The invention of claim 4, wherein said system is pre-programmed to run a sequence of takeoff, mid-air flight time, and descent/landing maneuvers.

6. The invention of claim 4, wherein said system comprises
a radio receiver on or in said body,
said receiver being adapted to control the speeds of said motors and/or the pitch and orientation of said propellors, and
a remove radio transmitter for sending control signals to said receiver.

7. The invention of claim 6, wherein the transmitter is a cell phone.

8. The invention of claim 7, wherein the cell phone runs an app designed to control the decoy.

9. The invention of claim 6, further comprising flight control surfaces on said body, said surfaces having adjustable positions which are controlled by said receiver.

10. The invention of claim 3, wherein said animal is a fowl, and the decay has portions resembling wings of a fowl.

11. The invention of claim 10, wherein the propellors are disposed in apertures in the respective wings.

12. The invention of claim 10, wherein the propellors are mounted adjacent to the body of the decoy.
